(19) United States
(12) Patent Application Publication
(10) Pub. No.: US 2021/0104004 A1
(43) Pub. Date: Apr. 8, 2021

(54) METHOD OF PROVIDING TRANSPORTATION SERVICE FOR PROTECTING PERSONAL INFORMATION OF USER

(71) Applicant: LG Electronics Inc., Seoul (KR)

(72) Inventor: Soryoung KIM, Seoul (KR)

(21) Appl. No.: 16/715,645

(22) Filed: Dec. 16, 2019

(30) Foreign Application Priority Data
Oct. 7, 2019 (KR) 10-2019-0123765

(51) Int. Cl. G06Q 50/30; G06Q 30/02; G05D 1/02

(52) U.S. Cl. CPC G06Q 50/30; G05D 2201/0213; G05D 1/0276; G06Q 30/0284

(57) ABSTRACT

Disclosed herein is a method of generating a virtual profile and providing transportation services to a user using the virtual profile to protect the user's personal information, thereby requiring no personal information of the user to provide transportation services and relieving the user anxiety about revelation of personal information.

### CROSS-REFERENCE TO RELATED APPLICATION

This application claims priority to and the benefit of Korean Patent Application No. 10-2019-0123765, filed in Korea on Oct. 7, 2019, the disclosure of which is incorporated herein by reference in its entirety.

### BACKGROUND

### 1. Field

The present disclosure relates to a method of generating a virtual profile and providing transportation services to a user using the virtual profile to protect the user's personal information.

### 2. Background

When it comes to vehicle call services, a user requests a transportation company to allocate a vehicle through an application installed in a mobile device, and calls the allocated vehicle to a location of the user to move to a destination.

In latest autonomous vehicle call services, when a user requests allocation of an autonomous vehicle, certification of identity between the user who requests allocation of the vehicle and a user who boards the vehicle is additionally required.

In this procedure, the user is required to provide the user's personal information for vehicle allocation and/or for user certification to a server of a service provider (e.g., a transportation company).

Various types of personal information of the user, provided for the above-described purposes, are cumulatively stored in the server of the service provider each time the user receives services, and accordingly, the user feels anxious about the safety of the user's personal information.

Thus, there is a growing need for a method of providing or receiving transportation services without revealing personal information.

### SUMMARY

A method of providing transportation services according to the present disclosure is directed to generating a virtual profile and providing transportation services to a user using the virtual profile.

Additionally, the method of providing transportation services is directed to certifying identity between a user who called an autonomous vehicle and a user who will board the autonomous vehicle.

Further, the method of providing transportation services is directed to deleting a virtual profile having been used to call an autonomous vehicle when a user alights from the autonomous vehicle, or to deleting a specific virtual profile when the virtual profile is used to call an autonomous vehicle a certain number of times or more.

Furthermore, the method of providing transportation services is directed to applying actual driving information of an autonomous vehicle to a virtual profile.

Objectives of the present disclosure are not limited to what has been described. Additionally, other objectives and advantages that have not been mentioned may be clearly understood from the following description and may be more clearly understood from embodiments. Further, it will be understood that the objectives and advantages of the present disclosure may be realized via means and a combination thereof that are described in the appended claims.

According to one aspect of the subject matter described in this application, a method of providing transportation services includes: receiving driving information from a user terminal; generating a virtual profile corresponding to the driving information and a virtual account corresponding to the virtual profile, and cumulatively storing the virtual profile and the virtual account in a database; receiving a vehicle call signal including a location of a destination from the user terminal; calculating an expected driving fare on the basis of a location of the user terminal and the location of the destination; identifying one or more virtual accounts storing the expected driving fare with reference to the database, and providing one or more virtual profiles corresponding to the identified virtual account to the user terminal; receiving any one virtual profile for driving selected by the user among the one or more virtual profiles from the user terminal; and allocating an autonomous vehicle to the location of the user terminal on the basis of the received virtual profile for driving.

The present disclosure may provide transportation services to a user by generating and using a virtual profile, thereby requiring no personal information of the user and relieving the user's anxiety about revelation of personal information in providing transportation services.

Additionally, the present disclosure may certify identity between a user who called an autonomous vehicle and a user who will board the autonomous vehicle, thereby preventing an uncertified user from boarding the autonomous vehicle and enhancing security in providing services.

Further, the present disclosure may delete a virtual profile having been used to call an autonomous vehicle when a user alights from the autonomous vehicle, or may delete a specific virtual profile when the virtual profile is used to call an autonomous vehicle a certain number of times or more, thereby preventing exposure of various types of driving information to which a driving tendency of the user is applied although the driving information is not personal information.

Furthermore, the present disclosure may apply actual driving information of an autonomous vehicle to a virtual profile, thereby enabling an autonomous vehicle to move in a way that is more suitable for a user when the user calls an autonomous vehicle using the same virtual profile later.

Detailed effects of the present disclosure are described together with the above-described effects in the detailed description of the disclosure.

### BRIEF DESCRIPTION OF THE DRAWINGS

Embodiments are described in detail with reference to the following drawings, wherein:

FIG. 1 is a view illustrating a transportation-service providing system according to an embodiment;

FIGS. 2a to 2c are views for describing a process of generating a virtual profile of a user;

FIG.3 is a flow chart illustrating a process of allocating an autonomous vehicle to a user;

FIG. 4 is a view illustrating an autonomous vehicle searching for a user terminal using certification information;

FIG. 5 is a flow chart illustrating a process of certifying a user when the user boards an autonomous vehicle;

FIG. 6 is a flow chart illustrating a method of managing a virtual profile for driving and a virtual account corresponding to the virtual profile for driving according to a drop off of a user;

FIG. 7 is a view illustrating interactions between a user terminal and a vehicle management server in a 5G communication system; and

FIGS. 8 to 11 are views illustrating operations of a user terminal using 5G communication based on each example.

### DETAILED DESCRIPTION

The above-described objectives, features and advantages are specifically described with reference to the attached drawings hereunder such that one having ordinary skill in the art to which the present disclosure pertains may easily implement the technical spirit of the disclosure. In describing the disclosure, detailed description of known technologies in relation to the disclosure is omitted if it is deemed to make the gist of the present disclosure unnecessarily vague. Below, preferred embodiments of the present disclosure are specifically described with reference to the attached drawings. Throughout the drawings, identical reference numerals denote identical or similar components.

In describing components of the present disclosure, the terms such as first, second, and the like may be used. These terms are only intended to distinguish a component from another component, and, unless explicitly stated otherwise, a first component may denote a second component.

When a component is described as being “connected” to another component, it will be understood that the components may be directly “connected” or an additional component may be “interposed” between the two components, or the two components may be “connected” through an additional component.

The singular forms “a”, “an” and “the” are intended to include the plural forms as well, unless explicitly indicated otherwise. It will be further understood that the terms “comprise” or “have,” when used in this specification, should not be interpreted as necessarily including stated components, or steps but may be interpreted as including some of the stated components or steps or should be interpreted as further including additional components or steps.

The terms “A or B”, “at least one of A or/and B”, or “one or more of A or/and B” as used herein include all possible combinations of items enumerated with them. For example, “A or B”, “at least one of A and B”, or “at least one of A or B” means (1) including at least one A, (2) including at least one B, or (3) including both at least one A and at least one B.

The present disclosure relates to a method of generating a virtual profile to protect personal information of a user and providing transportation services to the user using the virtual profile.

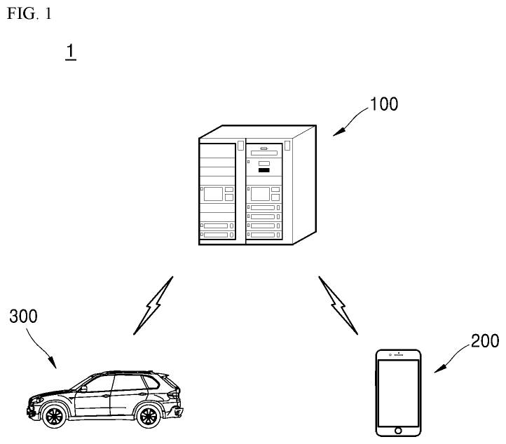

Below, a transportation-service providing system and a method in which the system provides transportation services to a user, according to an embodiment, are specifically described with reference to FIGS. 1 to 6. Hereunder, the term “vehicle” includes an autonomous vehicle, and the terms “vehicle” and “autonomous vehicle” are mixedly used.

FIG. 1 is a view illustrating a transportation-service providing system according to an embodiment.

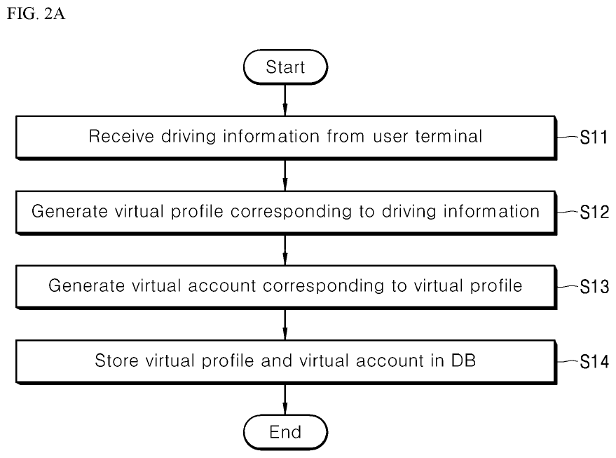

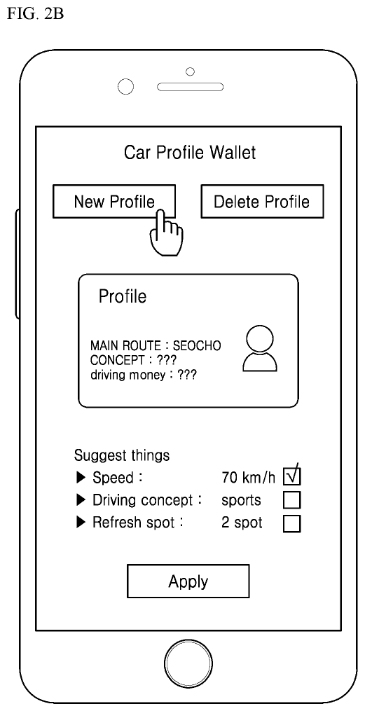

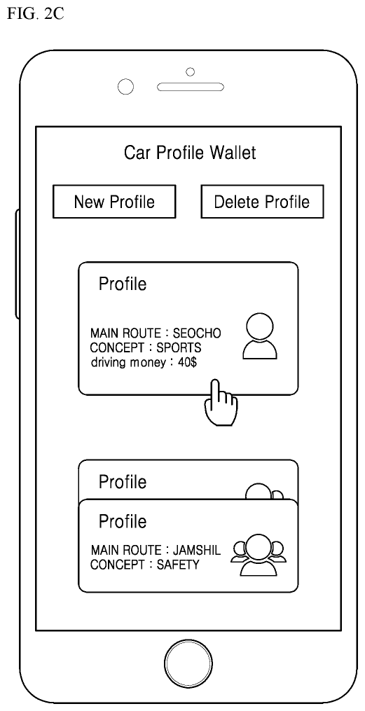

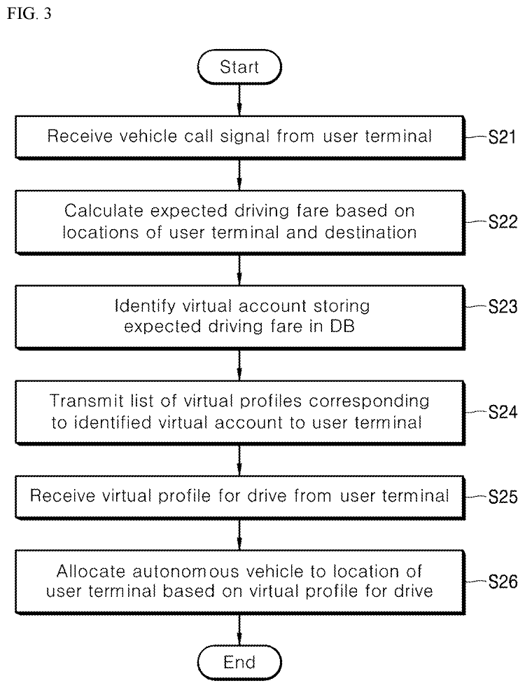

FIGS. 2a to 2c are views for describing a process of generating a virtual profile of a user, and FIG. 3 is a flow chart illustrating a process of allocating an autonomous vehicle to a user.

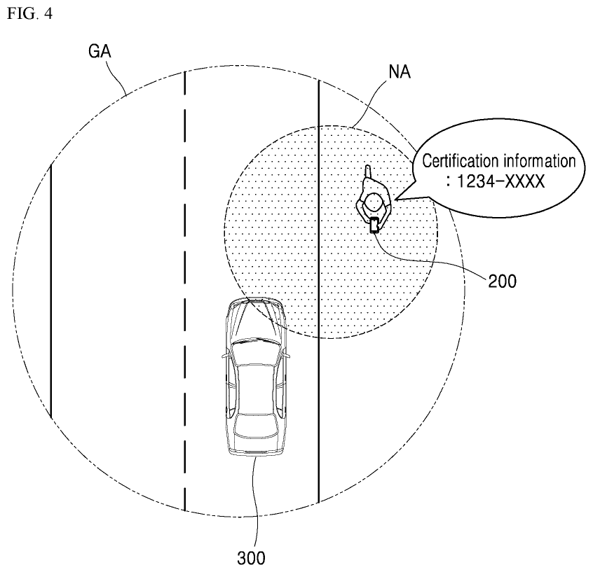

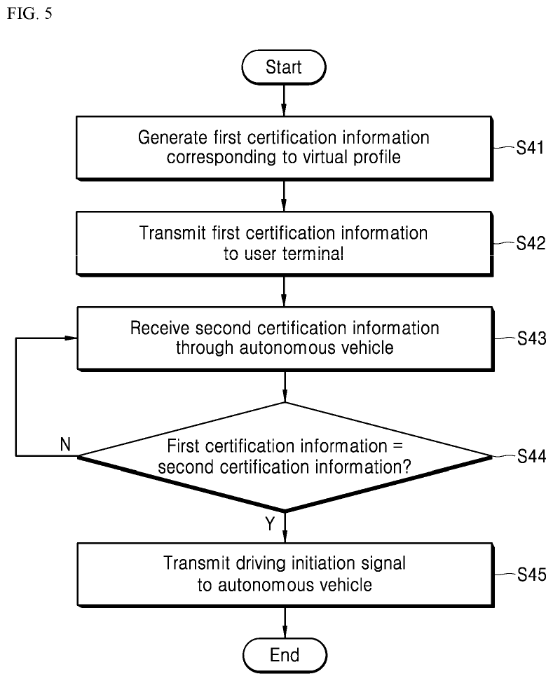

FIG. 4 is a view illustrating an autonomous vehicle searching for a user terminal using certification information, and FIG. 5 is a flow chart illustrating a process of certifying a user when the user boards an autonomous vehicle.

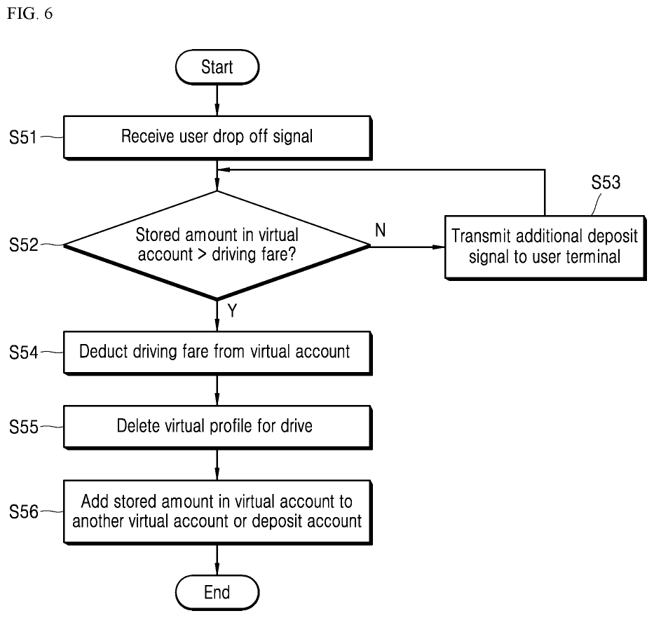

FIG. 6 is a flow chart illustrating a method of managing a virtual profile for driving and a virtual account corresponding to the virtual profile for driving according to a drop off of a user.

Referring to FIG. 1, a transportation-service providing system 1 according to an embodiment may include a vehicle management server 100, a user terminal 200, and an autonomous vehicle 300. Each component constituting the transportation-service providing system 1 may connect to a wireless network and may perform mutual data communication, and may use the 5^{th} Generation (5G) communications system for data communication.

The user terminal 200 may be any terminal that may perform wireless data communication. For example, the user terminal 200 may be implemented as a mobile device such as a smart phone, a tablet and the like that are equipped with a communication module.

The vehicle management server 100 may store and manage information collected by the autonomous vehicle 300 and the user terminal 200, and may perform operations of allocating the autonomous vehicle 300 to transport a user and of providing driving information to guide driving of the vehicle, and the like. The vehicle management server 100 may be managed by a transportation company that operates autonomous vehicles 300, or may be managed by any platform that provides an optimal driving path of a vehicle on the basis of a high-definition (HD) map and traffic information.

The vehicle management server 100 may include one or more physical components among application specific integrated circuits (ASICs), digital signal processors (DSPs), digital signal processing devices (DSPDs), programmable logic devices (PLDs), field programmable gate arrays (FPGAs), processors, controllers, microcontrollers, and microprocessors.

The method of providing transportation services according to the present disclosure may be performed by the transportation-service providing system 1. In other words, the vehicle management server 100, the user terminal 200, and the autonomous vehicle 300 may provide transportations services to a user by performing mutual data communication.

Below, the method of providing transportation services is described on the basis of each of the processes of 1) generating a virtual profile to allocate an autonomous vehicle 300 (hereinafter referred to as a process of generating a virtual profile), 2) allocating the autonomous vehicle 300 to a user (hereinafter referred to as a process of allocating an autonomous vehicle 300, 3) certifying the user (hereinafter referred to as a process of certifying a user, 4) providing transportation services through the autonomous vehicle 300 (hereinafter referred to as a process of operation), and 5) collecting driving fares and deleting the virtual profile (hereinafter referred to as a process of collecting fares and deleting a virtual profile.

First, the process of generating a virtual profile is described with reference to FIG. 2a. The process of generating a virtual profile may include receiving driving information from a user terminal 200 (S11), generating a virtual profile corresponding to the driving information (S12), generating a virtual account corresponding to the virtual profile (S13), and storing the virtual profile and the virtual account in a database (DB) (S14).

The process of generating a virtual profile illustrated in FIG. 2a is provided as an example, and each of the steps constituting the disclosure is not limited to the example in FIG. 2a. When necessary, some of the steps may be added, modified or removed.

Prior to allocation and operation of an autonomous vehicle 300, a vehicle management server 100 may receive driving information from a user terminal 200 (S11).

Specifically, referring to FIG. 2b, a transportation application for calling the autonomous vehicle 300 may be installed in the user terminal 200, and a user may input driving information through an interface supplied by the transportation application.

The transportation application may supply an interface implemented as a checkbox, a pull-down menu and the like, and the user may input driving information by selecting desired driving information from the checkbox or the pull-down menu. When the driving information is input, the user terminal 200 may transmit the driving information to the vehicle management server 100 through the transportation application.

The driving information may include any information in relation to driving through the autonomous vehicle 300. For example, the driving information may include information on a driving concept of the autonomous vehicle 300 (e.g., safety mode, sport mode, environmentally friendly mode, fuel efficient mode, romantic mode and the like), on a driving area (e.g., Seoul, Busan and the like), on a main route (e.g., a way to work from home), on a maximum driving speed (e.g., 120 km/h), on a preferred lane (e.g., the third lane), on a preferred road (e.g., a highway, a national road and the like), on frequency of stops at a rest area, on an accompanied passenger and the like.

Additionally, the driving information, which is a wide range of biographical date not specific to an individual, may include information on gender, on age groups (the 20's age group, the 30's age group and the like), on disability and the like.

When receiving the driving information, the vehicle management server 100 may generate a virtual profile corresponding to the driving information and virtual account corresponding to the virtual profile (S12, and S13).

Specifically, the vehicle management server 100 may group various types of information included in the driving information and may generate any one virtual profile corresponding to the grouped information. Further, the vehicle management server 100 may generate a virtual account corresponding to the generated virtual profile. The vehicle management server 100 may show the generated virtual profile and the virtual account corresponding to the generated virtual profile to the user through the transportation application.

That is, the vehicle management server 100 may generate the virtual profile using only the driving information that does not include personal information at all, and may generate the virtual account for charging fares incurred for using a vehicle through the virtual profile.

The vehicle management server 100 may generate a virtual profile and a virtual account corresponding to the virtual profile each time the vehicle management server 100 receives driving information from the user terminal 200, and may cumulatively store the virtual profile and the virtual account in the database (S14).

For example, referring to FIG. 2c, the user may input driving information such as a main route of Seocho and a driving concept of sport mode, and the vehicle management server 100 may generate a first virtual profile and a first virtual account corresponding to the driving information.

Additionally, the user may input driving information, which includes information on a main route of Jamsil, a driving concept of safety mode, and an accompanied passenger, and the vehicle management server 100 may generate a second virtual profile and a second virtual account corresponding to the driving information.

Then the user may deposit 40$ in the first virtual account to receive transportation services through the first virtual profile, and may check an amount stored in each virtual account through the transportation application.

The virtual profile and the virtual account that are cumulatively stored may be stored for each user of the transportation application. Specifically, the user may subscribe through the transportation application to receive transportation services, and may be given a personal ID. Then when the user generates a plurality of virtual profiles according to the above-described method, each generated virtual profile and a virtual account corresponding to each generated virtual profile may be cumulatively stored in the database based on the ID of the user.

Next, the process of allocating an autonomous vehicle 300 is described with reference to FIG. 3. The process of allocating an autonomous vehicle 300 may include receiving a vehicle call signal from the user terminal 200 (S21), calculating an expected driving fare on the basis of a location of the user terminal 200 and a location of the destination (S22), identifying a virtual account storing the expected driving fare in the database (S23), and transmitting a list of virtual profiles corresponding to the identified virtual account to the user terminal 200 (S24).

Further, the process of allocating an autonomous vehicle 300 may include receiving a virtual profile for driving from the user terminal 200 through a selection of any one virtual profile by the user among the list of virtual profiles (S25), and allocating an autonomous vehicle 300 to a location of the user terminal 200 on the basis of the virtual profile for driving (S26).

The process of allocating an autonomous vehicle 300 illustrated in FIG. 3 is provided as an example, and each of the steps constituting the disclosure is not limited to the example in FIG. 3. When necessary, some of the steps may be added, modified or removed.

The vehicle management server 100 may receive a vehicle call signal including a location of a destination from the user terminal 200 (S21).

Specifically, when receiving a location of a destination and then receiving a user instruction for calling a vehicle, input by the user through the transportation application, the user terminal 200 may generate a vehicle call signal including the location of a destination and may transmit the vehicle call signal to the vehicle management server 100.

The user terminal 200 may include a Global Locationing System (GPS) module, and the GPS module may calculate a location of the GPS module by interpreting satellite signals output by an artificial satellite. The GPS module is included in the user terminal 200. Accordingly, the location calculated by the GPS module may be a location of the user terminal 200. The location of the user terminal 200 may be transmitted to the vehicle management server 100 in real time.

The vehicle management server 100 may calculate an expected driving fare on the basis of the location of the destination included in the vehicle call signal and on the basis of the location of the user terminal 200 received in real time (S22). In other words, the vehicle management server 100 may calculate an expected driving fare incurred for operating the autonomous vehicle 300 from a current location of the user terminal 200 to a location of a destination.

The vehicle call signal may further include the type of an autonomous vehicle 300. Specifically, the vehicle call signal may further include information on the type of an autonomous vehicle 300 the user desires to call (e.g., a convertible, a sedan, a compact cart, a vehicle exclusively for disabled passengers, and the like).

In this case, the vehicle management server 100 may calculate an expected driving fare further considering the type of an autonomous vehicle 300. For example, when the type of an autonomous vehicle 300 included in the vehicle call signal is a compact car, the vehicle management server 100 may calculate that an expected driving fare incurred for moving to a location of a destination would be $30. When the type of an autonomous vehicle 300 included in the vehicle call signal is a convertible, the vehicle management server 100 may calculate that an expected driving fare incurred for moving to a location of a destination would be $60.

Next, the vehicle management server 100 may identify one or more virtual accounts storing the expected driving fare with reference to the database (S23).

The database, as described above, may store a plurality of virtual accounts corresponding to the user's ID. The vehicle management server 100 may compare a stored amount in each virtual account with the expected driving fare, and may identify one or more virtual accounts with a stored amount more than the expected driving fare.

If there is no virtual account with a stored amount greater than the expected driving fare, the vehicle management server 100 may transmit a message that says the stored amount in the virtual account is short to the user terminal 200, and the user may see the message through the transportation application.

Then the vehicle management server 100 may identify one or more virtual profiles corresponding to the identified virtual account, and may transmit the one or more virtual profiles to the user terminal 200 (S24).

A single virtual account may correspond to a single virtual profile. Accordingly, the vehicle management server 100 may identify a virtual profile corresponding to a virtual account with a stored amount greater than the expected driving fare, and may transmit the identified virtual profile to the user terminal 200.

If there are a plurality of virtual accounts with a stored amount greater than the expected driving fare, the vehicle management server 100 may identify a plurality of virtual profiles corresponding to each virtual account, and may transmit a list including the plurality of virtual profiles to the user terminal 200.

Next, the vehicle management server 100 may receive any one virtual profile for driving, selected by the user, from the user terminal 200, among one or more virtual profiles transmitted to the user terminal 200 (S25).

Specifically, when the vehicle management server 100 transmits the list of virtual profiles to the user terminal 200, the user may select any one virtual profile for driving, which will be used to call a vehicle, through the transportation application among the plurality of virtual profiles included in the list. The virtual profile for driving selected by the user may be transmitted to the vehicle management server 100.

Next, the vehicle management server 100 may allocate the autonomous vehicle 300 to the location of the user terminal 200 on the basis of the virtual profile for driving (S26).

The virtual profile for driving may correspond to various pieces of driving information, and the vehicle management server 100 may allocate an autonomous vehicle 300 matched with the driving information to the location of the user terminal 200. For example, in the case in which a driving concept included in the virtual profile for driving is safety mode, in which a maximum driving speed is 80km/h, in which a preferred road is a national road, and in which the type of a vehicle is a vehicle exclusively for disabled passengers, the vehicle management server 100 may search for an autonomous vehicle 300 corresponding to the above-described driving information, and may allocate the searched autonomous vehicle 300 to the location of the user terminal 200.

The autonomous vehicle 300 matched with the driving information may be located within a reference distance from the location of the user terminal 200. In other words, the vehicle management server 100 may only allocate an autonomous vehicle 300, located within a reference distance from the location of the user terminal 200, to the location of the user terminal 200.

Further, a plurality of autonomous vehicles 300 may be matched with driving information. In this case, the vehicle management server 100 may supply a list of a plurality of autonomous vehicles 300 that are located within a reference distance from the location of the user terminal 200 and that are matched with the driving information to the user terminal 200.

The list of a plurality of autonomous vehicles 300 may be displayed through the transportation application, and the user may select any one vehicle among the list of a plurality autonomous vehicles 300. Accordingly, the user terminal 200 may transmit a selection signal for any one vehicle to the vehicle management server 100, and the vehicle management server 100 may allocate any one vehicle corresponding to the selection signal to the location of the user terminal 200.

The preset disclosure, as described above, may generate virtual profiles and may provide transportation services to a user using the virtual profiles, thereby requiring no personal information of the user in providing the transportation services, and thus, relieving the user's anxiety about personal information exposure.

The autonomous vehicle 300 that is allocated according to the above-described method may move to the location of the user terminal 200. Specifically, the vehicle management server 100 may transmit the location of the user terminal 200 to the autonomous vehicle 300. The autonomous vehicle 300 may move to the location of the user terminal 200 along a driving path from a current location to the location of the user terminal 200.

However, as described above, the location of the user terminal 200, which is a location calculated by the GPS module in the user terminal 200, may have partial errors. Accordingly, a process in which the autonomous vehicle 300 finds out and moves to a location of the user accurately is described hereunder.

A vehicle management module may generate a virtual profile corresponding to driving information, may generate certification information corresponding to the virtual profile and then may transmit the certification information to the user terminal 200 and the autonomous vehicle 300. The certification information, which is any information for confirming whether a passenger who will board the autonomous vehicle 300 is identical with a user who called the autonomous vehicle 300, may be implemented as various means such as a text, an image and the like, and for example, may be implemented as a combination of numbers.

After the autonomous vehicle 300 arrives at the location of the user terminal 200, the autonomous vehicle 300 may search for the user terminal 200 on the basis of certification information received through a short-range wireless network.

Referring to FIG. 4, the autonomous vehicle 300 may arrive at the location of the user terminal 200, which is any location within an error range of the GPS (GA). Then, the autonomous vehicle 300 may receive the certification information by activating a short-range wireless network.

Specifically, when the user terminal 200 receives the certification information of 1234-5678 from the vehicle management server 100, the user terminal 200 may transmit the certification information through a short-range wireless network (e.g., a wireless personal area network (WPAN), Bluetooth, Wi-Fi, a beacon, and the like).

When the autonomous vehicle 300 enters an area in which the autonomous vehicle 300 may receive the certification information transmitted from the user terminal 200 (hereinafter referred to as an area of a short-range wireless network (NA)), the autonomous vehicle 300 may receive the certification information. The autonomous vehicle 300 may search for the user terminal 200 by comparing the certification information previously received from the vehicle management server 100 with the certification information received from the user terminal 200.

Below, certification information transmitted to the autonomous vehicle 300 from the vehicle management server 100 is referred to as first certification information, and certification information transmitted to the autonomous vehicle 300 from the user terminal 200 is referred to as second certification information, for convenience of description.

The autonomous vehicle 300 may compare identity between the first certification information and the second certification information, and may search for a source of the second certification information the same as the first certification information. Specifically, the autonomous vehicle 300 may analyze a signal received through a short-range wireless network, may acquire the second certification information, and may compare identity between the acquired second certification information and the first certification information.

Through the comparison, the autonomous vehicle 300 may identify second certification information the same as the first certification information, and may search for a source of the second certification information on the basis of signal intensity of the second certification information, and may identify a detailed location of the user terminal 200. Accordingly, the autonomous vehicle 300 may move to the detailed location of the user terminal 200.

When all the certification information is transmitted from the user terminal 200, another vehicle or another user terminal 200 as well as the autonomous vehicle 300 allocated to the location of the user terminal 200 may receive the certification information. In this case, the certification information is likely to be exposed.

To prevent the exposure of the certification information, the user terminal 200 may transmit a signal only including a part of the certification information through a short-range wireless network. In this case, the autonomous vehicle 300 may compare identity between the certification information received from the vehicle management server 100 and a part of the certification information received through the short-range wireless network and may search for the user terminal 200.

Referring back to FIG. 4, the autonomous vehicle 300 and the user terminal 200 may respectively receive the certification information “1234-5678” from the vehicle management server 100. In this case, the user terminal 200 may transmit a signal only including a part of the certification information, e.g., a signal only including “1234” through the short-range wireless network.

When the autonomous vehicle 300 enters the area of a short-range wireless network (NA), the autonomous vehicle 300 may receive the certification information only including “1234” from the user terminal 200 and may determine whether “1234” is included in “1234-5678” previously received from the vehicle management server 100.

Through this, the autonomous vehicle 300 may identify second certification information the same as a part of the first certification information, may search for a source of the second certification information on the basis of signal intensity of the second certification information, and may identify a detailed location of the user terminal 200. Accordingly, the autonomous vehicle 300 may move to the detailed location of the user terminal 200.

When the autonomous vehicle 300 arrives at the detailed location of the user terminal 200, the user may board the autonomous vehicle 300. In this case, the vehicle management server 100 may certify whether the passenger who will board the autonomous vehicle 300 is the user who called the autonomous vehicle 300.

Below, certification information transmitted to the user terminal 200 from the vehicle management server 100 is referred to as first certification information, and certification information transmitted to the vehicle management server 100 from the autonomous vehicle 300 is referred to as second certification information, for convenience of description.

The process of certifying a user is described with reference to FIG. 5. The process of certifying a user may include generating first certification information corresponding to a virtual profile (S41), transmitting the first certification information to the user terminal 200 (S42), receiving second certification information through the autonomous vehicle 300 (S43), comparing identity between the first certification information and the second certification information (S44), and transmitting a driving initiation signal to the autonomous vehicle 300 (S45).

The process of certifying a user illustrated in FIG. 5 is provided as an example, and each of the steps constituting the disclosure is not limited to the example in FIG. 5. When necessary, some of the steps may be added, modified or removed.

After generating a virtual profile corresponding to driving information, the vehicle management module may generate certification information corresponding to the virtual profile (S41), and may transmit the certification information to the user terminal 200 (S42). Then the vehicle management server 100 may receive certification information corresponding to a virtual profile for driving through the autonomous vehicle 300 allocated to the location of the user terminal 200 (S43).

Specifically, the user may confirm the certification information through the transportation application, and may input the certification information through any human machine interface (HMI) provided in the autonomous vehicle 300 when the user boards the autonomous vehicle 300 that arrives at the location of the user terminal 200. The HMI may transmit the certification information input by the user to the vehicle management server 100.

The vehicle management server 100 may compare identity between first certification information generated in response to the virtual profile for driving and transmitted to the user terminal 200, and second certification information received through the autonomous vehicle 300 (S44), and may certify the user.

As described with reference to FIG. 4, even when a part of the certification information is used to search for a location of the user, the autonomous vehicle 300 may request input of all the certification information, and the vehicle management server 100 may certify the user on the basis of complete identity between the first certification information and the second certification information.

The vehicle management server 100 may repeat certification of the user until the second certification information the same as the first certification information is received, and, when the first certification information and the second certification information are the same, may transmit a driving initiation signal to the autonomous vehicle 300 (S45).

The driving initiation signal may be any signal that allows the user to board the autonomous vehicle and that allows the autonomous vehicle 300 to move for autonomous driving. When receiving the driving initiation signal from the vehicle management server 100, the autonomous vehicle 300 may start to move with the user aboard the vehicle 300.

The present disclosure, as described above, may certify identity between the user who called the autonomous vehicle 300 and the user who will board the autonomous vehicle 300, thereby preventing an uncertified user from boarding the autonomous vehicle 300 and enhancing security in providing services.

Next, the process of operating an autonomous vehicle 300 is described.

The vehicle management server 100 may transmit driving information corresponding to a virtual profile for driving selected by the user to the autonomous vehicle 300, and the autonomous vehicle 300 may move based on the driving information corresponding to the virtual profile for driving.

Referring to FIG. 2b, in the driving information corresponding to the virtual profile for driving, a main route may be set to Seocho, and a driving concept may be set to sport mode. In this case, the autonomous vehicle 300 may autonomously move to Seocho in sport mode. In the driving information corresponding to the virtual profile for driving, a main route may also be set to Jamsil, and a driving concept may also be set to safety mode. In this case, the autonomous vehicle 300 may autonomously move to Jamsil in safety mode.

Further, when the virtual profile for driving includes a maximum driving speed, a preferred lane, and a preferred road, the autonomous vehicle 300 may autonomously move on the preferred lane of the preferred road within the maximum driving speed.

The virtual profile for driving, as described above, may include information on an accompanied passenger. In this case, the autonomous vehicle 300 may move on the basis of additional driving information corresponding to the information on an accompanied passenger. The additional driving information may be applied to driving of the autonomous vehicle 300 prior to the above-described driving information.

For example, when the accompanied passenger is a child or an infant, in the additional driving information, a driving concept may be forcibly set to safety mode, and a maximum driving speed may be forcibly set to 60 km/h. In this case, even when a driving concept is set to sport mode, and a maximum driving speed is set to 120 km/h in driving information corresponding to the virtual profile for driving, the autonomous vehicle 300 may move in safety mode within the maximum driving speed of 60 km/h according to the additional driving information. Thus, the autonomous vehicle 300 with a child in it may move in safety mode at low speed all the time.

When the accompanied passenger is a girl friend or a boy friend, in the additional driving information, a driving concept may be forcibly set to romantic mode, and a preferred lane may be forcibly set to a lane close to a shoulder lane. In this case, even when a driving concept is set to safety mode, and a preferred lane is set to the first lane in driving information corresponding to the virtual profile for driving, the autonomous vehicle 300 may move in romantic mode on the lane close to the shoulder lane according to the additional driving information. Thus, the autonomous vehicle 300 with a girl friend or a boy friend in it may move along a path having great views, and may move on the lane close to the shoulder lane such that the girl friend or the boy friend may freely take pictures of the great views.

The autonomous vehicle 300 may move according to control of the user aboard the autonomous vehicle, in a different way from driving information corresponding to the virtual profile for driving. As a first example, even when the autonomous vehicle 300 moves according to the driving information in which a maximum driving speed is set to 80 km/h, the autonomous vehicle 300 may move according to control of the user at an increased speed of up to 120 km/h. As a second example, when the autonomous vehicle 300 moves according to the driving information in which a preferred lane is not set, the autonomous vehicle 300 may move on the third lane according to control of the user.

In this case, the vehicle management server 100 may receive actual driving information of the autonomous vehicle 300 from the autonomous vehicle 300, and may update the driving information corresponding to the virtual profile for driving with the actual driving information.

The autonomous vehicle 300 may store actual driving information in an internal memory, and may transmit the stored actual driving information to the vehicle management server 100. The vehicle management server 100 may update driving information stored in the database in response to the virtual profile for driving with actual driving information.

In the first example, the vehicle management server 100 may update a maximum driving speed of 80 km/h in the driving information corresponding to the virtual profile for driving with 120 km/h. Additionally, in the second example, the vehicle management server 100 may set a preferred lane not included in the driving information corresponding to the virtual profile for driving to the third lane.

The update of the vehicle management server 100 may require consent of the user, and the vehicle management server 100 may receive the consent of the user through the transportation application.

The present disclosure, as described above, may apply actual driving information of the autonomous vehicle 300 to the virtual profile, thereby enabling the autonomous vehicle 300 to move in a way that is more suitable for the user when the user calls the autonomous vehicle 300 using the same virtual profile later.

Finally, the process of collecting fares and deleting a virtual profile is described with reference to FIG. 6. The process of collecting fares and deleting a virtual profile may include receiving a user drop off signal (S51), comparing a stored amount in a virtual account with a driving fare (S52), transmitting an additional deposit signal to the user terminal 200 when the stored amount in the virtual account is less than the driving fare (S53), deducting the driving fare from the virtual account (S54), deleting a virtual profile for driving (S55), and adding the stored amount in the virtual account to another virtual account or another deposit account (S56).

The process of collecting fares and deleting a virtual profile illustrated in FIG. 6 is provided as an example, and each of the steps constituting the disclosure is not limited to the example in FIG. 6. When necessary, some of the steps may be added, modified or removed.

The vehicle management server 100 may receive a user drop off signal from at least one of the user terminal 200 and the autonomous vehicle 300 (S51).

When the autonomous vehicle 300 arrives at a destination or when the user wants to alight from the autonomous vehicle 300, the user may input a user drop off signal through at least one of the transportation application installed in the user terminal 200 and the HMI in the autonomous vehicle 300, and the user terminal 200 and/or the HMI may transmit the user drop off signal to the vehicle management server 100.

The vehicle management server 100 may determine a driving fare on the basis of a driving distance moved by the autonomous vehicle 300 and driving time taken by the autonomous vehicle 300. The vehicle management server 100 may also identify a driving fare through a fare meter installed in the autonomous vehicle 300.

When receiving the user drop off signal, the vehicle management server 100 may deduct the driving fare from a virtual account or may transmit an additional deposit signal to the user terminal 200 depending on a stored amount in the virtual account corresponding to the virtual profile for driving.

Specifically, the vehicle management server 100 may compare a stored amount in a virtual account corresponding to the virtual profile for driving with a driving fare of the autonomous vehicle 300 (S52). When the driving fare is not stored in the virtual account as a result of comparison, i.e., when a stored amount in the virtual account is less than the driving fare as a result of comparison, the vehicle management server 100 may transmit an addition deposit signal to the user terminal 200.

In other words, when a stored amount in the virtual account corresponding to the virtual profile for driving is more than an expected driving fare that is described in step 22, and less than an actual driving fare, the vehicle management server 100 may transmit an additional deposit signal to the user terminal 200.

The transportation application in the user terminal 200 may display an interface requesting a deposit into the virtual account according to the additional deposit signal, and the user may put an additional amount into the virtual account according to the interface.

When the driving fare is stored in the virtual account as a result of comparison in step 52, i.e., when a stored amount in the virtual account is more than the driving fare as a result of comparison in step 52, the vehicle management server 100 may deduct the driving fare from the virtual account (S54). For example, when a stored mount in the virtual account is $30 and the driving fare is $28, the vehicle management server 100 may deduct the driving fare of $28 from the stored amount of $30 in the virtual account. Accordingly, the stored amount in the virtual account is $2.

Additionally, when receiving the user drop off signal from at least one of the user terminal 200 and the autonomous vehicle 300, the vehicle management server 100 may delete the virtual profile for driving from the data base (S55).

In other words, a virtual profile for driving in the present disclosure is disposable, and, after the virtual profile for driving is used, may be completely deleted from the database in the vehicle management server. Accordingly, various types of driving information corresponding to the virtual profile for driving may also be deleted.

In the case of a disposable virtual profile for driving, when a stored amount is left in the virtual account corresponding to the virtual profile for driving, the vehicle management server 100 may add the stored amount to a virtual account or a deposit account corresponding to another virtual profile (S56).

As an example, referring to FIG. 2c, the user may call the autonomous vehicle 300 using a virtual profile for driving in which a main route is set to Seocho and a stored amount in a virtual account is $40, and a driving fare of the autonomous vehicle 300 that moved to Seocho may be $35. The vehicle management module may deduct the driving fare from the stored amount in the virtual account, and, accordingly, the stored amount in the virtual account is $5.

In this case, the virtual profile for driving may be disposable, and the vehicle management module may add the stored amount of $5 in the virtual account corresponding to the virtual profile for driving to a virtual account corresponding to another virtual profile (e.g., a virtual profile in which a main route is set to Jamsil) to delete the virtual profile for driving from the database.

As another example, the vehicle management server 100 may generate a deposit account corresponding to a user ID, and the user may withdraw a deposited amount in the deposit account through the transportation application. In this case, to delete a virtual profile for driving, the vehicle management server 100 may add a stored amount in a virtual account corresponding to the virtual profile for driving to the deposit account at the same time as the vehicle management server 100 deletes the virtual account corresponding to the virtual profile for driving.

The vehicle management server 100 may also delete the virtual profile for driving from the database when a stored amount in the virtual account corresponding to the virtual profile for driving runs out. In other words, the virtual profile for driving may be used multiple times until a stored amount in the virtual account corresponding to the virtual profile for driving runs out.

For example, when the user uses a virtual profile for driving on a daily basis to travel to and from work, the user may steadily deposit an amount in a virtual account corresponding to the virtual profile for driving. In this case, the vehicle management server 100 may not delete the virtual profile for driving until all the stored amount in the virtual account corresponding to the virtual profile for driving runs out, and may delete the virtual profile for driving only when all the stored amount in the virtual account runs out.

The vehicle management server 100 may also delete the virtual profile for driving from the database when allocation frequency based on the virtual profile for driving reaches reference frequency. In other words, a virtual profile for driving may be used only with reference frequency regardless of a stored amount in a virtual account corresponding to the virtual profile for driving.

Driving information corresponding to a virtual profile for driving that has already been used to call a vehicle may be cumulatively stored in the autonomous vehicle 300. In providing transportation services, a large number of users may board any one autonomous vehicle 300. Accordingly, when any one virtual profile for driving is used multiple times, various types of driving information in the virtual profile for driving are likely exposed to another passenger aboard the autonomous vehicle 300.

To prevent the exposure, when any one virtual profile for driving is used with reference frequency to call an autonomous vehicle 300, the vehicle management server 100 may delete the virtual profile for driving from the database. To delete the virtual profile for driving, the vehicle management server, as described above, may add a stored amount in a virtual account corresponding to the virtual profile for driving to a virtual account or a deposit account corresponding to another virtual profile.

The present disclosure, as described above, may delete a virtual profile having been used to call an autonomous vehicle 300 when the user alights from the autonomous vehicle 300, or may delete a specific virtual profile when the virtual profile is used to call an autonomous vehicle 300 a certain number of times or more, thereby preventing exposure of various types of driving information to which a driving tendency of the user is applied although the driving information is not personal information.

Data communication performed by the above-described transportation-service providing system 1 may be carried out on 5G networks. For example, data communication between the vehicle management server 100 and the user terminal 200, and data communication between the vehicle management server 100 and the autonomous vehicle 300 may be performed on 5G networks.

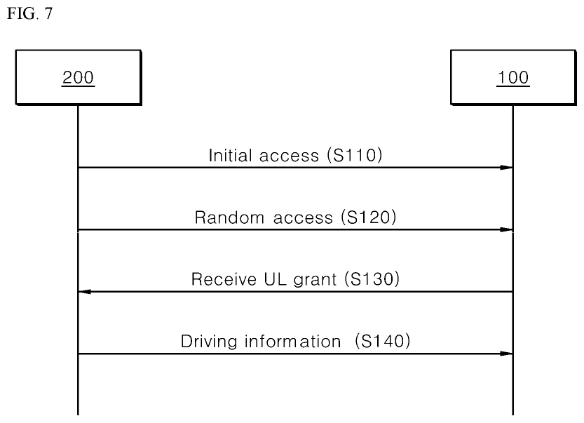

Below, a method of data communication on 5G networks is described with reference to FIGS. 7 to 11. For convenience of description, a process in which the user terminal 200 transmits driving information to the vehicle management server 100 is described as an example.

FIG. 7 is a view illustrating interactions between a user terminal 200 and a vehicle management server 100 in a 5G communication system.

The user terminal 200 may make initial access to the vehicle management server 100 (S110).

The process of initial access may include a cell search for acquiring downlink (DL) operation, acquisition of system information, and the like.

Additionally, the user terminal 200 may make random access to the vehicle management server 100 (S120).

The process of random access may include transmitting preamble, receiving a response to random access, and the like to acquire uplink (UL) synchronization or to transmit UL data.

Additionally, the vehicle management server 100 may transmit a UL grant for scheduling transmission of driving information to the user terminal 200 (S130).

Receiving a UL grant may include receiving time/frequency resource scheduling to transmit UL data to the vehicle management server 100.

Additionally, the user terminal 200 may transmit driving information to the vehicle management server 100 on the basis of the UL grant (S140).

Though not illustrated in FIG. 7, to receive a virtual profile from the vehicle management server 100, the user terminal 200 may receive a DL grant through a physical downlink control channel. In this case, the vehicle management server 100 may transmit the virtual profile to the user terminal 200 on the basis of the DL grant.

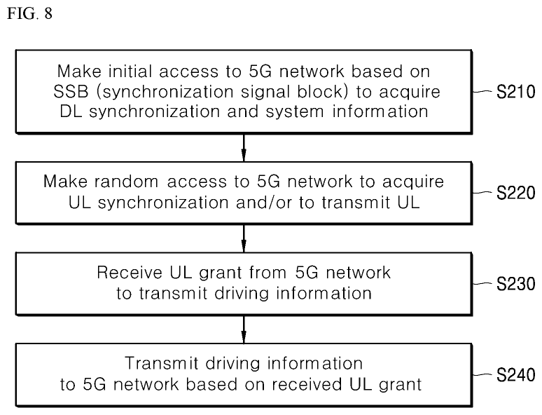

FIGS. 8 to 11 are views illustrating operations of a user terminal 200 using 5G communication based on each example.

Referring to FIG. 8, the user terminal 200 may make initial access to the vehicle management server 100 on the basis of a synchronization signal block (SSB) to acquire DL synchronization and system information (S210).

Additionally, the user terminal 200 may make random access to the vehicle management server 100 to acquire UL synchronization and/or to transmit UL (S220).

Additionally, the user terminal 200 may receive a UL grant from the vehicle management server 100 to transmit driving information (S230).

Additionally, the user terminal 200 may transmit the driving information to the vehicle management server 100 on the basis of the UL grant (S240).

Beam management (BM) may be added in step 210, beam failure recovery in relation to physical random access channel (PRACH) transmission may be added in step 31, a QCL relation concerning a direction of reception of beams of PDCCH including a UL grant may be added in step 230, and a QCL relation concerning a direction of transmission of beams of physical uplink control channel (PUCCH)/physical uplink shared channel (PUSCH) including driving information may be added in step 240.

Though not illustrated in FIG. 8, to receive a virtual profile from the vehicle management server 100, the user terminal 200 may receive a DL grant from the vehicle management server 100 and may receive the virtual profile from the vehicle management server 100 on the basis of the DL grant.

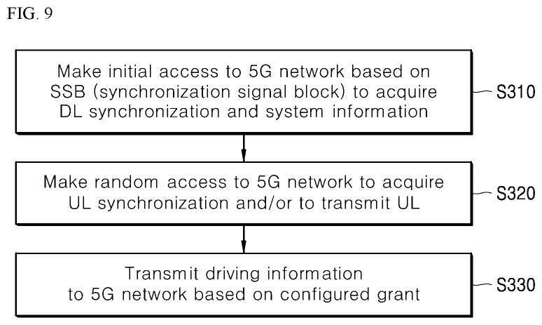

Referring to FIG. 9, the user terminal 200 may make initial access to the vehicle management server 100 on the basis of SSB to acquire DL synchronization and system information (S310).

Additionally, the user terminal 200 may make random access to the vehicle management server 100 to acquire UL synchronization and/or to transmit UL (S320).

Additionally, the user terminal 200 may transmit driving information to the vehicle management server 100 on the basis of a configured grant (S330). In other words, instead of receiving a UL grant from the vehicle management server 100, the user terminal 200 may also transmit the driving information to the vehicle management server 100 on the basis of the configured grant.

Though not illustrated in FIG. 9, to receive a virtual profile from the vehicle management server 100, the user terminal 200 may receive the virtual profile from the vehicle management server 100 on the basis of the configured grant.

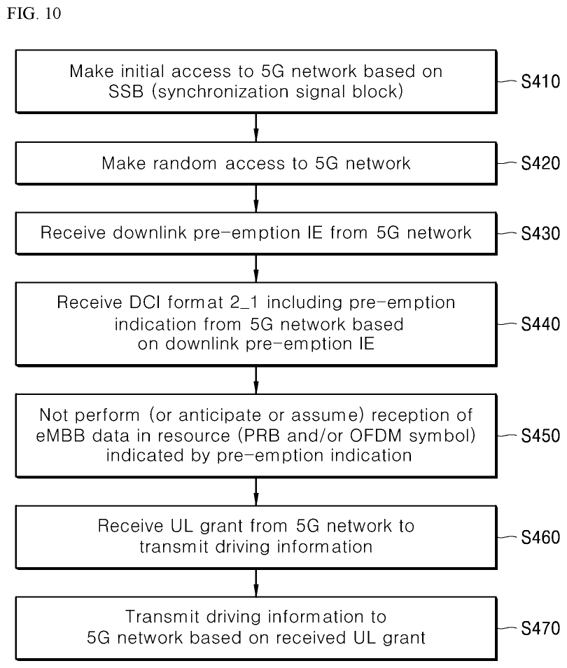

Referring to FIG. 10, the user terminal 200 may make initial access to the vehicle management server 100 on the basis of SSB to acquire DL synchronization and system information (S410).

Additionally, the user terminal 200 may make random access to the vehicle management server 100 to acquire UL synchronization and/or to transmit UL (S420).

Additionally, the user terminal 200 may receive downlink pre-emption IE from the vehicle management server 100 (S430).

Additionally, the user terminal 200 may receive DCI format 2_1 including a pre-emption indication from the vehicle management server 100 on the basis of the downlink pre-emption IE (S440).

Additionally, the user terminal 200 may not perform (or anticipate or assume) reception of eMBB data in a resource (PRB and/or OFDM symbol) indicated by the pre-emption indication (S450).

Additionally, the user terminal 200 may receive a UL grant from the vehicle management server 100 to transmit driving information (S460).

Additionally, the user terminal 200 may transmit driving information to the vehicle management server 100 on the basis of the UL grant (S470).

Though not illustrated in FIG. 10, the user terminal 200 may receive the DL grant from the vehicle management server 100 to receive a virtual profile from the vehicle management server 100, and may receive the virtual profile from the vehicle management server 100 on the basis of the DL grant.

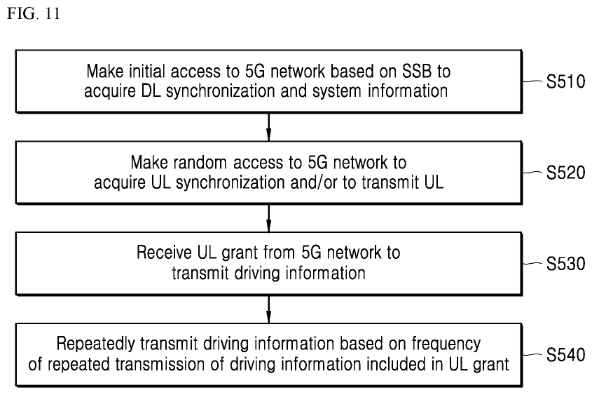

Referring to FIG. 11, the user terminal 200 may make initial access to the vehicle management server 100 on the basis of SSB to acquire DL synchronization and system information (S510).

Additionally, the user terminal 200 may make random access to the vehicle management server 100 to acquire UL synchronization and/or to transmit UL (S520).

Additionally, the user terminal 200 may receive a UL grant from the vehicle management server 100 to transmit driving information (S530).

The UL grant may include information on frequency of repeated transmission of driving information, and the driving information may be repeatedly transmitted on the basis of the information on frequency of repetition (S540).

Additionally, the user terminal 200 may transmit the driving information to the vehicle management server 100 on the basis of the UL grant.

Repeated transmission of the driving information may be performed through frequency hopping, and first transmission of driving information may be transmitted in a first frequency resource, and second transmission of driving information may be transmitted in a second frequency resource.

Driving information may be transmitted through a narrowband of 6 resource block (RB) or 1 resource block (RB).

Though not illustrated in FIG. 11, the user terminal 200 may receive a DL grant from the vehicle management server 100 to receive a virtual profile from the vehicle management server 100, and may receive the virtual profile from the vehicle management server 100 on the basis of the DL grant.

In FIGS. 7 to 11, data communication between the user terminal 200 and the vehicle management server 100 is described on the basis of the process of transmitting driving information and the process of receiving a virtual profile. However, the above-described communication method may also be applied to any signal transmitted and received between the vehicle management server 100 and the autonomous vehicle 300.

The above-described 5G communication technology may compensate a method of data communication performed in the transportation-service providing system 1 of the present disclosure to specify and clarify the method. However, the method of data communication of the present disclosure is not limited to 5G communication, and data communication may be performed through various methods that are being used in the art to which the disclosure pertains.

The present disclosure has been described with reference to the embodiments illustrated in the drawings. However, the disclosure is not limited to the embodiments and the drawings set forth herein. Further, various modifications may be made by one having ordinary skill in the art within the scope of the technical spirit of the disclosure. Further, though not explicitly described during description of the embodiments of the disclosure, effects and predictable effects according to the configuration of the disclosure should be included in the scope of the disclosure.

What is claimed is:

1. A method of providing transportation services, comprising:
receiving driving information from a user terminal;
generating a virtual profile corresponding to the driving information and a virtual account corresponding to the virtual profile, and cumulatively storing the virtual profile and the virtual account in a database;
receiving a vehicle call signal including a location of a destination from the user terminal;
calculating an expected driving fare on the basis of a location of the user terminal and the location of the destination;
identifying one or more virtual accounts storing the expected driving fare with reference to the database, and providing one or more virtual profiles corresponding to the identified virtual account to the user terminal;
receiving any one virtual profile for driving selected by the user among the one or more virtual profiles from the user terminal; and
allocating an autonomous vehicle to the location of the user terminal on the basis of the received virtual profile for driving.

2. The method of claim 1, wherein the method further comprises transmitting driving information corresponding to the virtual profile for driving to the autonomous vehicle; and
wherein the autonomous vehicle moves based on the driving information corresponding to the virtual profile for driving.

3. The method of claim 1, further comprising:
receiving a user drop off signal from at least one of the user terminal and the autonomous vehicle; and
deducting a driving fare of the autonomous vehicle from a virtual account corresponding to the virtual profile for driving.

4. The method of claim 3, wherein when the virtual account corresponding to the virtual profile for driving does not store the driving fare of the autonomous vehicle, the method includes transmitting an additional deposit signal to the user terminal.

5. The method of claim 1, further comprising:
receiving a user drop off signal from at least one of the user terminal and the autonomous vehicle; and
deleting the virtual profile for driving from the database.

6. The method of claim 5, wherein when a virtual account corresponding to the virtual profile for driving has a stored amount, the method further includes adding the stored amount to a virtual account or a deposit account corresponding to an additional virtual profile.

7. The method of claim 1, further comprising:
deleting the virtual profile for driving from the database when a stored amount in a virtual account corresponding to the virtual profile for driving runs out.

8. The method of claim 1, further comprising:
deleting the virtual profile for driving from the database when allocation frequency according to the virtual profile for driving reaches reference frequency.

9. The method of claim 1, wherein the virtual profile for driving includes information on an accompanied passenger, and
the autonomous vehicle moves on the basis of additional driving information corresponding to the information on an accompanied passenger.

10. The method of claim 1, wherein the step of receiving a vehicle call signal includes receiving a vehicle call signal further including the type of the autonomous vehicle, and
the step of calculating an expected driving fare includes calculating the expected driving fare further considering the type of the autonomous vehicle.

11. The method of claim 1, wherein when a virtual profile corresponding to the driving information is generated, the method further comprises generating certification information corresponding to the virtual profile and transmitting the certification information to the user terminal and the autonomous vehicle, and
wherein the autonomous vehicle searches for the user terminal on the basis of the certification information received through a short-range wireless network.

12. The method of claim 11, wherein the user terminal transmits a signal including a part of the certification information through the short-range wireless network, and
the autonomous vehicle searches for the user terminal by comparing identity between certification information corresponding to the virtual profile with a part of certification information received through the short-range wireless network.

13. The method of claim 1, further comprising:
when a virtual profile corresponding to the driving information is generated, generating certification information corresponding to the virtual profile and transmitting the certification information to the user terminal;
receiving certification information corresponding to the virtual profile for driving through the autonomous vehicle allocated to the location of the user terminal; and
certifying a user by comparing certification information generated in response to the virtual profile for driving with certification information received through the autonomous vehicle.

14. The method of claim 1, the step of allocating the autonomous vehicle to a location of the user terminal, comprising:
providing a list of a plurality of autonomous vehicles within a reference distance from the location of the user terminal to the user terminal;
receiving a selection signal for any one vehicle among the plurality of autonomous vehicles from the user terminal; and
allocating the any one vehicle corresponding to the selection signal to the location of the user terminal.

15. The method of claim 1, wherein the method further comprises receiving actual driving information of the autonomous vehicle from the autonomous vehicle; and updating driving information corresponding to the virtual profile for driving with the actual driving information.
